(19) United States
(12) Patent Application Publication
(10) Pub. No.: US 2025/0142461 A1
(43) Pub. Date: May 1, 2025

(54) COMMUNICATION APPARATUS, CONTROLMETHOD, AND STORAGE MEDIUM

(71) Applicant: CANON KABUSHIKI KAISHA, Tokyo (JP)

(72) Inventor: YUKI YOSHIKAWA, Kanagawa (JP)

(21) Appl. No.: 19/012,558

(22) Filed: Jan. 7, 2025

Related U.S. Application Data
(63) Continuation of application No. PCT/JP2023/023251, filed on Jun. 23, 2023.

(30) Foreign Application Priority Data
Jul. 8, 2022 (JP) 2022-110738

(51) Int. Cl. H04W 48/16; H04W 28/18

(52) U.S. Cl. CPC H04W 48/16; H04W 28/18

(57) ABSTRACT

An access point (AP) that performs a transmitting, to a server, part or all of pieces of information with the information included in an inference request, an acquiring a result of the inference of the quality of the communication, a determining whether to perform the roaming processing, and, a notifying, in a case where it is determined to perform the roaming processing, said other communication apparatus of a performance of the roaming processing.

### CROSS-REFERENCE TO RELATED APPLICATIONS

This application is a Continuation of International Patent Application No. PCT/JP2023/023251, filed Jun. 23, 2023, which claims the benefit of Japanese Patent Application No. 2022-110738, filed Jul. 8, 2022, both of which are hereby incorporated by reference herein in their entirety.

### BACKGROUND

### Technical Field

The present disclosure relates to a communication apparatus conforming to the IEEE802.11 standard.

The IEEE802.11 series standard is known as a communication standard related to a Wireless Local Area Network (WLAN) (hereinafter referred to as a WLAN). The latest IEEE802.11be standard implements high-peak-throughput low-delay communication by using a Multi-Link technique (Japanese Patent Laid-Open No. 2018-50133).

For the successor standard of the Institute of Electrical and Electronics Engineers (IEEE) 802.11 standard, the introduction of Artificial Intelligence (AI) and Machine Learning (ML) is under consideration.

Meanwhile, a roaming technique is known in wireless communications conforming to the IEEE802.11 standard. Roaming refers to an operation in which a station (STA) in connection to a certain access point (AP) changes the connection destination to another AP. For example, if the STA becomes distant to the currently connected AP, the STA can change the connection destination to another AP installed at a closer point.

### SUMMARY

Machine learning may possibly be used to optimize the roaming in wireless communications. Conventionally, there have been no frame configuration and no data collection method used for data collection for implementing machine learning in roaming, and no training data usage.

In view of the above-described issues, the present disclosure is directed to implementing data collection and data communication therefor in order to allow the use of machine learning in roaming. According to another aspect of the present disclosure, it becomes possible to determine the necessity of roaming suitable for communication based on collected data and notify of a roaming destination.

In view of the above issues, a communication apparatus according to an aspect of the present disclosure includes transmitting, to a server, part or all of pieces of information with the information included in an inference request, the pieces of information including station (STA) positional information, a threshold value for a radio wave intensity in Basic Service Set (BSS) movement, the number of STAs to which an Access point (AP) is connected, a radio wave intensity to be received from an STA to which the AP is connected, a radio wave status of surrounding APs indicated by the STA to which the AP is connected, information indicating a surrounding communication status indicated by the STA to which the AP is connected, a frequency band or channel supported by the STA to which the AP is connected, capability information for surrounding APs, and time-series data of any one of the pieces of information in unit time, wherein the inference request requests an inference of a quality of a communication with other communication apparatus in the case of performing a roaming processing, acquiring a result of the inference of the quality of the communication, determining whether to perform the roaming processing; and notifying, in a case where it is determined to perform the roaming processing, said other communication apparatus of a performance of the roaming processing.

### BRIEF DESCRIPTION OF THE DRAWINGS

FIG. 1 illustrates an example of a network configuration.

FIG. 2 illustrates an example of a hardware configuration of an access point (AP) and a station (STA).

FIG. 3 illustrates examples of function blocks including the AP and the STA.

FIG. 4 is a conceptual diagram illustrating a structure using a learning model including input data, a learning model, and output data.

FIG. 5 illustrates an example of a system processing flow according to the present disclosure.

FIG. 6 is a flowchart illustrating an example of processing of the AP according to the present disclosure.

FIG. 7 is a flowchart illustrating an example of processing of a data collection server according to the present disclosure.

FIG. 8 is a flowchart illustrating an example of processing of an inference server in a learning phase according to the present disclosure.

FIG. 9 is a flowchart illustrating an example of processing of the inference server in an inference phase according to the present disclosure.

FIG. 10 illustrates an example of an STA report request frame according to the present disclosure.

FIG. 11 illustrates an example of an STA report response frame according to the present disclosure.

FIG. 12 illustrates an example of an STA report classification according to the present disclosure.

### DESCRIPTION OF EMBODIMENTS

### First Exemplary Embodiment

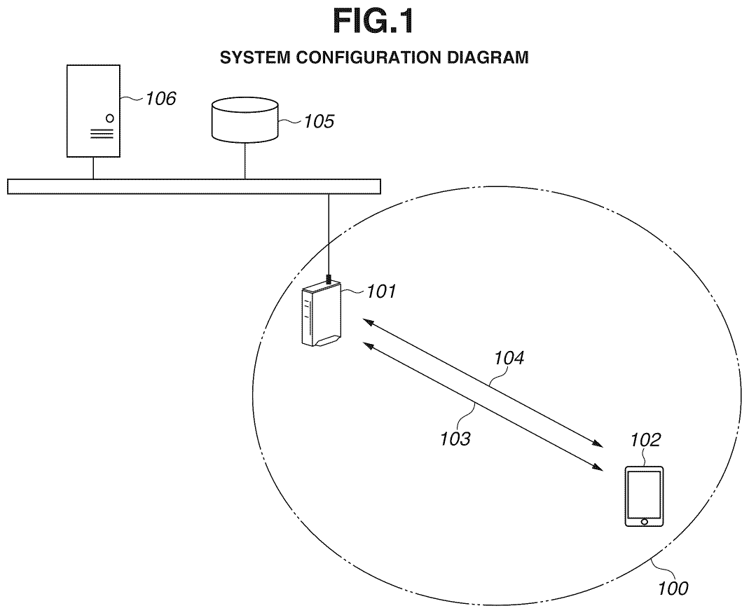

FIG. 1 illustrates an example of a network configuration according to a first exemplary embodiment. A wireless communication system illustrated in FIG. 1 is a wireless network including an AP 101, an STA 102, a data collection server 105, and an inference server 106. The AP has functions similar to those of the STA except for a relay function, and therefore has a form of the STA.

The AP 101 communicates with each STA 102 according to a wireless communication method conforming to the Institute of Electrical and Electronics Engineers (IEEE) 802.11 standard. STAs 102 in a circle 100 indicating the coverage of the signal transmitted by the AP 101 can communicate with the AP 101. According to the present exemplary embodiment, the AP 101 and each STA 102 communicate with each other according to the IEEE802.11 standard. The AP 101 establishes wireless links 103 and 104 with each STA 102 via a predetermined association process. Although FIG. 1 illustrates an example of a multi-link connection using two different links, the number of wireless links may be one, or more than two.

The AP 101 connects to the data collection server 105 and the inference server 106 via the Internet. The AP 101 may connect to the data collection server 105 and the inference server 106 in any desired form. The number of STAs and the number of APs may be two or more. For example, other APs as candidates for the roaming may be present in the system.

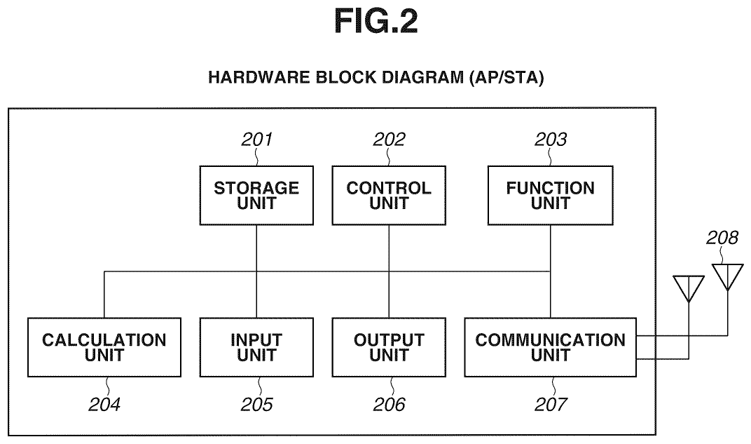

FIG. 2 illustrates a hardware configuration of an AP and an STA according to the present disclosure. As an example, the hardware configuration includes a storage unit 201, a control unit 202, a function unit 203, a calculation unit 204, an input unit 205, an output unit 206, a communication unit 207, and an antenna 208.

The storage unit 201 includes memories such as a Read Only Memory (ROM) and a Random Access Memory (RAM) and stores programs for performing various operations (described below) and various information such as communication parameters for wireless communications. Storage media applicable as the storage unit 201 include not only the ROM and RAM but also a flexible disk, hard disk, optical disk, magneto-optical disk, compact disc read only memory (CD-ROM), compact disc recordable (CD-R), magnetic tape, nonvolatile memory card, and digital versatile disc (DVD). The storage unit 201 may also include a plurality of memories.

The control unit 202 includes, for example, processors such as a central processing unit (CPU) and micro processing unit (MPU), application specific integrated circuit (ASIC), digital signal processor (DSP), and field programmable gate array (FPGA). CPU is an abbreviation for Central Processing Unit, and MPU is an abbreviation for Micro Processing Unit. The CPU executes a program stored in the storage unit 201 to control the AP. The control unit 202 may control the AP 101 through the collaboration between a program and an operating system (OS) stored in the storage unit 201. The control unit 202 may include a plurality of processors such as a multi-core to control the AP.

The control unit 202 controls the function unit 203 to perform predetermined processing such as the AP function, imaging, printing, and projection. The function unit 203 is a hardware component used by the AP to perform predetermined processing.

The calculation unit 204 includes, for example, a processor such as a graphics processing unit (GPU) and a tensor processing unit (TPU), an application specific integrated circuit (ASIC), a digital signal processor (DSP), and a field programmable gate array (FPGA).

Referring to the example illustrated in FIG. 1, the data collection server 105 and the inference server 106 to be used for machine learning are prepared separately from the AP 101 and the STAs 102, the functions of these servers may be integrated in the AP 101 and the STA 102. In this case, the calculation unit 204 operates as a hardware component for performing inference calculations using a result of machine learning and for calculating machine learning itself. GPU is an abbreviation for Graphical Processing Unit, and TPU is an abbreviation for Tensor Processing Unit. The TPU is an example of a systolic array type hardware processor dedicated for machine learning, and is provided with such calculation resources as buffer resistors disposed adjacently to a product sum calculation unit and a product sum calculator, and activation functions implemented by hardware. The TPU includes an instruction decoder for interpreting a TPU instruction to designate a calculation flow to control the above-described calculation resources. The TPU functions is called a neural processing unit (NPU).

These processors may share some calculations to perform calculations in cooperation with the control unit 202. Since the GPU and TPU are capable of performing effective calculations through parallel processing of a large amount of data, processing through the GPU and TPU is effective in a case where learning is performed a plurality of times by using a learning model as in deep learning. Thus, in the present exemplary embodiment, for the processing by a training unit of the inference server, the GPU and/or the TPU are/is used for the calculation unit 204 in addition to the control unit 202. More specifically, in a case where a training program including a learning model is executed, the control unit 202 or the calculation unit 204 performs the training by performing calculations in collaboration with each other. The processing of the training unit may be performed only by the control unit 202 or the calculation unit 204. An inference unit may also use the calculation unit 204 as with the training unit.

The input unit 205 receives various operations from the user. The output unit 206 provides the user with various outputs. Outputs by the output unit 206 include at least one of display on a screen, sound output by a speaker, and vibration output. Both the input unit 205 and the output unit 206 may be implemented by a single module, such as a touch panel.

The communication unit 207 is capable of performing wireless communication conforming to the successor standard of the IEEE802.11 EHT standard (also referred to as 802.11be standard), aiming for a maximum transmission rate of 90 to 100 Gbps. The successor standard of the 802.11be standard aims for supporting high-reliability communication and low-latency communication as next targets to be achieved. In view of the above, according to the present exemplary embodiment, the successor standard of the IEEE802.11be standard aiming for a maximum transmission rate of 90 to 100 Gpbs is tentatively called IEEE802.11 HR (High Reliability).

The name IEEE802.11 HR is given for convenience in consideration of targets to be achieved by the successor standard and features of the relevant standard. The name may be changed when the standard is established. The scope of the present specification and the appended claims are essentially the successor standard of the 802.11be standard, and are applicable to all successor standards that can support wireless communications.

The communication unit 207 performs encoding/decoding and modulation/demodulation processing on wireless communication data conforming to the IEEE802.11 standard series such as the IEEE802.11EHT and the IEEE802.11 HR standards. The communication unit 207 also controls Wi-Fi wireless communications and Internet Protocol (IP) communications. The communication unit 207 further controls the antenna 208 to transmit and receive wireless signals for wireless communications.

As illustrated in FIG. 1, in a case where the data collection server 105 and the inference server 106 used for machine learning are provided separately from the AP 101 and the STA 102, the servers include what is called a von Neumann computer. More specifically, the servers include at least one memory and at least one processor corresponding to the control unit 202, and calculation resources such as a GPU and a TPU corresponding to the calculation unit 204. In this case, the GPU and TPU of the servers operate as hardware components for performing inference calculations using a result of machine learning and for calculating machine learning itself.

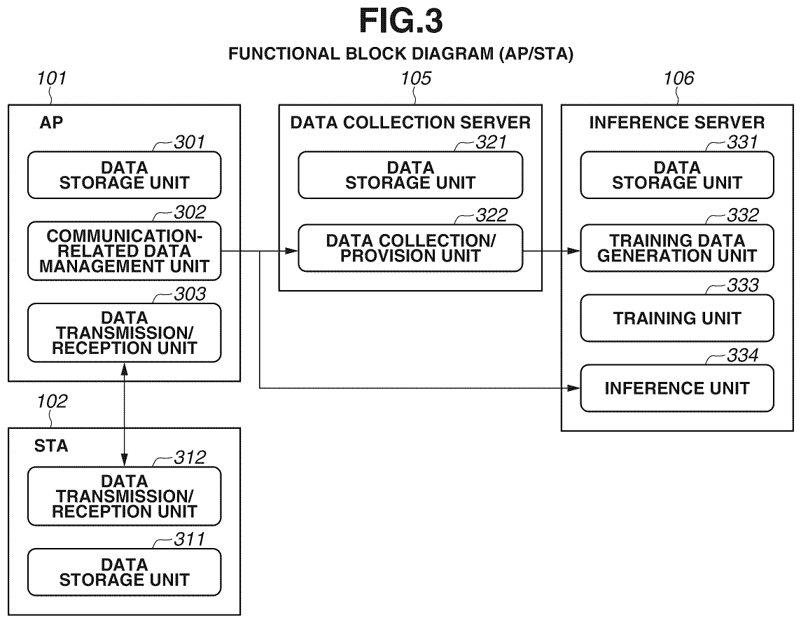

FIG. 3 illustrates a functional block of the training system according to the present disclosure. The STA 102 includes a data transmission/reception unit 312 for transmitting and receiving surrounding information collected by the communication unit 207 and information accumulated in the storage unit 201, via the communication unit 207 and the antenna 208. A data storage unit 311 is used as the storage unit 201.

The AP 101 includes a data transmission/reception unit 303 for receiving data transmitted by the STA 102 and also transmitting data from the AP 101 to the STA 102. The AP 101 and the STA 102 use the communication unit 207 and the antenna 208 for these data communications. The AP 101 also includes a data storage unit 301 for storing data in the storage unit 201. The storage unit 201 and the control unit 202 are expanded, and a communication-related data management unit 302 is included. The communication-related data management unit 302 cooperates with the data collection server and the inference server to transmit input data required for training, receive a result of inference, and communicate requests therefor.

The data collection server accumulates data collected from the AP 101 and other APs in a data storage unit 321. The data accumulated in the inference server is transmitted via a data collection/provision unit 322, as required.

The inference server receives input information and result data obtained from the data collection server and generates a learning model via a training data generation unit 332 and a training unit 333. The generated learning model is stored in a data storage unit 331. In response to receiving an inference value request from the AP 101, the inference values is calculated by using a result of learning in the inference unit 334, and the result is returned to the AP 101. If the functions of the data collection server 105 and the inference server 106 used for machine learning are incorporated into the AP 101 and/or the STA 102, a single apparatus such as the AP 101 or the STA 102 includes all of the functions illustrated in FIG. 3. If the data collection server 105 and the inference server 106 used for machine learning are provided as different apparatuses from the AP 101 and the STA 102, the data collection and inference functions is to be performed by the servers as different apparatuses, as described above. Although, in the example case in FIG. 3, the servers as different apparatuses perform both training and inference, the present exemplary embodiment is not limited thereto. The inference processing may be implemented by the AP 101. In this case, the inference server 106 transmits trained model data generated based on the received input and output data, to the AP 101. In this case, it is sufficient that the AP 101 is configured to have the function of the inference unit 334. The AP 101 stores the trained model data received from the server 106. It is sufficient that the inference unit 334 of the AP 101 is configured to calculate inference values by using the inference input data and the trained model data obtained from the surrounding environment that the AP 101 itself collects and the operating status.

The training unit 333 may include an error detection unit and an updating unit. The error detection unit obtains an error between teacher data and output data output from an output layer of a neural network in accordance with input data input to an input layer. The error detection unit may calculate an error between the teacher data and the output data output from the neural network by using a loss function.

The updating unit updates a coupling weighting coefficient between nodes of the neural network to reduce the error obtained by the error detection unit. The updating unit updates the coupling weighting coefficient, for example, by using the error back propagation method. The error back propagation method is a method for adjusting a coupling weighting coefficient between nodes of each neural network to reduce the error.

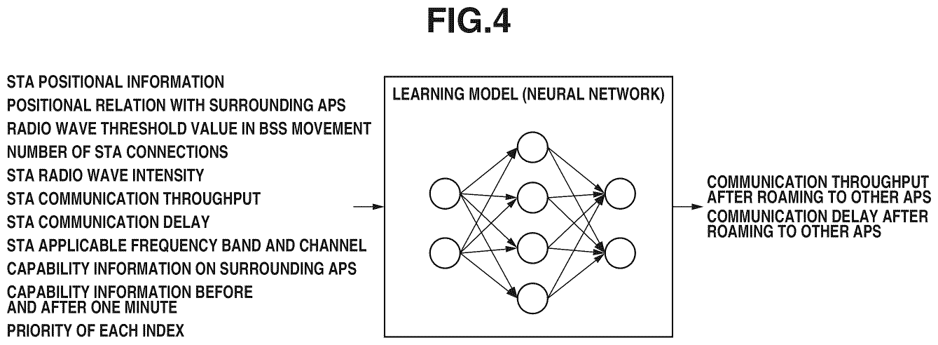

FIG. 4 is a conceptual diagram illustrating an input and output configuration using the learning model according to the present exemplary embodiment. Examples of the input data of the learning model include information about the position of the STA 102, information about the positional relation with the AP 101, a radio wave threshold value for determining a basic service set (BSS) movement, the number of STAs in connection to the AP 101, and the radio wave intensity of the STA 102. Examples of the input data include the communication throughput with the STA 102 before roaming, the communication delay with the STA 102 and other STAs, STA capability information such as the applicable frequency band, channel, and band width of the STA 102 and other STAs. Examples of the input data also include the capability information for the AP 101 and surrounding APs. Examples of the capability information include the band width (described above), error correction encoding method (BCC and LDPC), Number of Streams (NSS) indicating the number of streams, Modulation and Coding Scheme (MCS) indicating the modulation method. The information about the above-described applicable frequency band may be expressed, for example, in Operation Class.

Examples of the usable input data also include Signal-to-Noise Ratio (SNR) indicating the ratio of the signal exchanged between the STA and the AP to noise.

Examples of the input data further include the communication throughput requested by applications, the communication delay, and the priority of each index. The priority of each index is a manually set weighting parameter which can be omitted depending on the machine learning method. Variations of the above-described information in predetermined unit time with respect to certain time, i.e., time series data of the above-described information may be used as an input parameter. Although in the present exemplary embodiment, one minute or around is used as an example of the unit time, the present exemplary embodiment is not limited thereto.

The capability information for surrounding APs is an example of information indicating the surrounding communication status.

For example, position and radio wave status such as the positional relation between the STA and the AP, and the radio wave intensity have a certain correlation with the communication quality after the roaming. For example, the communication quality after the roaming tends to improve to a further extent with a closer positional relation. For example, an improvement of the communication quality after the roaming is not likely to be anticipated to a further extent with a further positional relation. The number of connections to APs also has a certain correlation with the communication quality after the roaming. With a large number of connections to APs after the roaming, an improvement of the communication quality after the roaming is not likely to be anticipated. With a small number of connections to APs before the roaming, an improvement of the communication quality after the roaming is not likely to be anticipated. Conversely, with a small number of connections to APs after the roaming, an improvement of the communication quality after the roaming is likely to be anticipated. With a large number of connections to APs before the roaming, an improvement of the communication quality after the roaming is likely to be anticipated. Also, supportable frequency band and channel of STA 102, and the capability information about surrounding APs are parameters relating to the surrounding congestion status, the possibility of congestion avoidance, and the communication throughput. This congestion information has a certain correlation with the communication quality after the roaming. For example, in a case where an AP of the channel not comparatively congested after the roaming is to be connected, an improvement of the communication quality is likely to be anticipated. On the contrary, in a case where an AP of the channel comparatively congested is to be connected after the roaming, an improvement of the communication quality is not likely to be anticipated. The band width, Network Security Service (NSS), and Multi-Category Security (MCS) have a certain correlation with the communication quality after the roaming. For example, with a large band width or a large number of spatial streams used for communication with APs after the roaming or with a high encoding ratio, an improvement of the communication throughput is likely to be anticipated. On the contrary, with small values of the above-described parameters used for communication with APs after the roaming are small, an improvement of the communication quality is not likely to be anticipated.

The quality requirements such as the communication throughput and communication delay requested by applications have a certain correlation with the communication quality required after the roaming. If the quality requirements are not high, the communication quality to be requested after the roaming is likely to be guaranteed. If the quality requirements are high, the communication quality to be requested after the roaming is likely to be hard to be guaranteed. The communication throughput and communication delay before the roaming have a certain correlation with the communication quality after the roaming. If the status(es) of the communication throughput and/or communication delay before the roaming is/are unfavorable, an improvement of the communication quality after the roaming is likely to be anticipated. If the status(es) of the communication throughput and/or communication delay before the roaming is/are favorable, an improvement of the communication quality after the roaming is not likely to be anticipated. The value of SNR has a certain correlation with the communication quality. If SNR after the roaming is high, noise hardly affects and therefore an improvement of the communication quality is likely to be anticipated. If SNR after the roaming is low, noise largely affects and an improvement of the communication quality is not likely to be anticipated.

As described above, each input parameter has a certain trend with the roaming. In the communication space, these parameters are complicatedly related with each other, and determine whether the communication quality improves after the roaming. However, since the parameters are complicatedly related with each other, it is difficult to logically determine a threshold value for the determination.

On the contrary, if the necessity or unnecessity of roaming is inferred with an input of a plurality of parameters that clearly exhibit certain trends, it is highly likely that whether the communication quality improves after the roaming can be inferred. In view of the above, in the present exemplary embodiment learning is performed, where some combinations of the above-described parameters or all the parameters are set to input data with the use of a data set that recognizes the data indicating the effect of roaming in a case where the roaming is actually performed as correct answer data. Table 1 illustrates an example of a data set for learning which associates the input parameters with correct answer parameters. The teacher data may include information about the error rate after the roaming.

TABLE 1

| | Input data | | | | | | |
|---|---|---|---|---|---|---|---|
| | | | Radio wave | | | | |
| | | | reception | | Teacher data | | |
| Training | AP | STA | intensity of | | Throughput | Communication | |
| data ID | ID | ID | candidate APs | . . . | after roaming | delay after roaming | |
| 1 | 101 | 102 | −92 dBm | . . . | 128 Mbps | 0.1 | sec. |
| 2 | 101 | 107 | −80 dBm | | 130 Mbps | 2 | sec. |
| 3 | 108 | 110 | −100 dBm | . . . | 20 Mbps | 0.3 | sec. |
| . . . | . . . | . . . | . . . | . . . | . . . | . . . | |
| N | 170 | 197 | −50 dBm | . . . | 430 Mbps | 0.01 | sec. |

The STA positional information may be the relative distance from the AP 101, the distances from surrounding APs, or positional information acquired by a Global Positioning System (GPS). Examples of the positional information include information, such as N35°21.636′, E138°43.640′, and 3775.6 m above sea level. The positional information may be movement data for past 10 minutes in addition to one at the current point. The moving direction and the moving speed may also be usable. The positional relation between surrounding APs and the AP 101 may be the relative distance or positional relation between the AP 101 and each of extracted APs that locates within 50 meter from the AP 101. Alternatively, a distance from a wall near the location where the AP 101 is installed may be usable. Candidates of surrounding APs may be, for example, five different APs closest to the coordinates acquired based on the STA positional information. The STA positional information after five minutes that is predicted from the STA positional information may be usable. Alternatively, APs from which the AP 101 and the STA 102 can actually receive a radio wave may be applicable. In this case, the AP 101 and/or the servers may narrow down APs to the APs that operates with the same Extended Service Set Identifier (ESSID) out of all the candidates.

A radio wave threshold value for determination of a BSS movement may be, for example, a threshold value of the reception radio wave intensity receivable by the AP 101.

The communication throughput and communication delay requested by an application may be in a step-by-step manner. For example, an absolute minimum required communication throughput could be 10 Mbps, while the preferred throughput might be 100 Mbps. Similarly, for communication delay, a maximum allowable latency could be 10 seconds, while the desired latency might be 0.01 seconds. The APs indicated by AP ID 108 and AP ID 170 are examples of other APs that can serve as candidates for which STAs in connection to the AP 101 performs roaming.

Combinations of the input data and the teacher data illustrated in Table 1 can be generated as follows. Initially, an STA records information indicating a measured effect of the past roaming. The STA compares the communication throughput and communication delay before with those after performing the roaming. If the communication throughput increases and the communication delay decreases as a result of performing the roaming, the roaming is regarded as being successful and information indicating that the effect of the roaming is favorable is stored. Otherwise, information indicating that the effect of the roaming is unfavorable is stored. The STA stores the AP ID of the roaming source, the AP ID after the roaming, the position and time at which/when the roaming is performed, the radio wave intensity before and after the roaming, throughput performance and communication delay performance after the roaming, an error rate in communication in association with one another. If no data is accumulated and no trained model data is built, the communication system according to the present exemplary embodiment performs predefined algorithm-based roaming processing, which is a conventional technique. For example, a roaming request is issued in a case where the radio wave intensity becomes lower than a predetermined threshold value.

Subsequently, the STA periodically transmits the stored information indicating the effect of the past roaming to connected APs (e.g., the AP 101 and other APs). The AP 101 and other APs store these pieces of information. The AP 101 and other APs further periodically collect the radio wave status and positional relations with surrounding APs and store these pieces of information in association with the time of the collection. The AP 101 and other APs periodically transmit information about the effect of the roaming received from the STA and the information collected and stored by the AP 101 and the other APs, to the collection server 105. The collection server 105 generates metadata for learning based on the data obtained from the AP and the STA and transmits the data to the inference server 106.

The training data generation unit 332 of the inference server 106 generates a data set for learning (a combination of the input value and the teacher data) based on the received metadata. For a data set to be used for the generation and update of the learning model, either one or both of the data indicating the favorable effect and the data indicating the unfavorable effect may be reflected.

An inference result obtained by inputting data for inference to the trained model includes an inferred communication throughput and an inferred communication delay after the roaming. Model data may be built so that the error rate is further inferenced as an inference result.

The inference server 106 or the AP 101 compares inference values after the roaming with current measurement data to determine the necessity of the roaming. If the present value is assumed to be improved, the roaming is recommended and information for the roaming destination AP is acquired. The output of the learning model may include whether to the roaming is to be performed or not.

In a case where the roaming is actually performed, the measurement values may be updated and accumulated as data for learning.

Examples of specific machine learning algorithms include the nearest neighbor method, naive Bayes method, decision tree, and support vector machine. Examples of specific algorithms also include deep learning for generating feature quantities for learning and coupling weighting coefficients by using a neural network. Any one of the above-described usable algorithms can be suitably applied to the present exemplary embodiment.

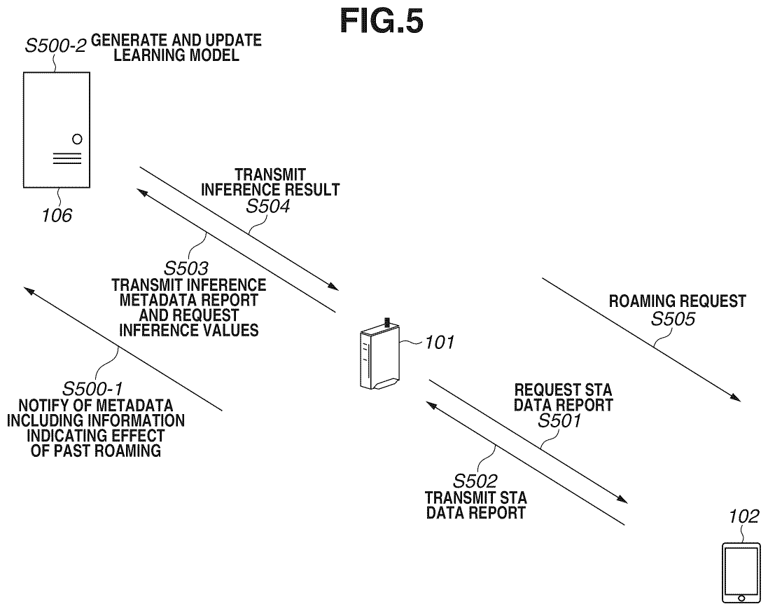

FIG. 5 illustrates system operations to which the present disclosure using the structure of the learning model illustrated in FIG. 4 is applicable. In step S500-1, the AP 101 and other APs provide the inference server 106 with metadata including the information indicating the effect of the past roaming, via the collection server 105. In step S500-2, the inference server 106 performs processing for generating and/or updating the learning model. The processing for generation and/or update is performed based on a data set in which the metadata accumulated in the inference server 106 and the information indicating the effect of the past roaming received in step S500-1 are combined. The processing is periodically performed at the timing when a predetermined amount of new data has been accumulated. In step S501 and the subsequent steps, the inference processing using the generated or updated trained model will be described.

In step S501, the AP 101 requests the STA 102 to report STA data. The STA data refers to information used as the input data to be used for learning and inference illustrated in FIG. 4, such as the surrounding environment of the STA and positional information about the STA and the information indicating the effect of the past roaming. Examples thereof include the STA positional information, surrounding APs that are able to receive a radio wave, their radio wave intensities, capability information, and radio wave reception intensity of the AP 101. This request may be issued using, for example, a Radio Measurement Action frame. In the request, for each piece of information is requested using Radio Measurement Request, Link Measurement Request, and Neighbor Report Request. STA Report Request may be defined to collect data required for learning and inference. In response to this request, the STA 102 transmits a report of the STA data. For example, in the report, a Radio Measurement Action frame may be used. Each piece of information is requested by using Radio Measurement Request, Link Measurement Request, and Neighbor Report Request. New STA Report Request and Response may be defined to collect data required for learning and inference, such as information indicating the effect of the roaming.

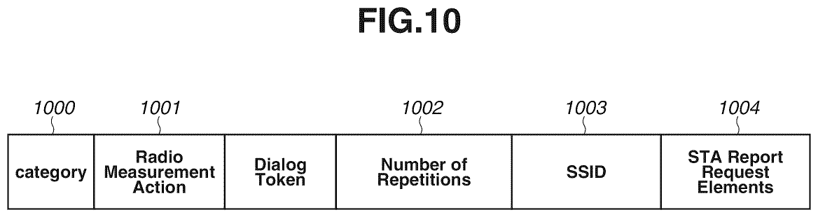

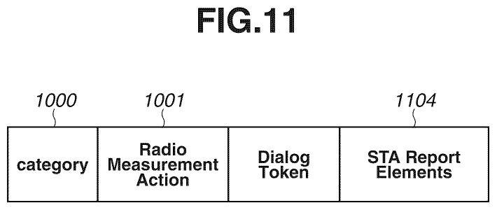

Further, a request and a response frame illustrated in FIGS. 10 and 11 may be used. FIGS. 10 and 11 illustrate examples of frames to be used to issue a request and a response, respectively, related to STA data collection.

The request frame includes Category 1000, Radio Measurement Action 1001, Number of Repetitions 1002, SSID 1003, and STA Report Request Elements 1004. The response frame includes Category 1000, Radio Measurement Action 1001, STA Report Elements 1104.

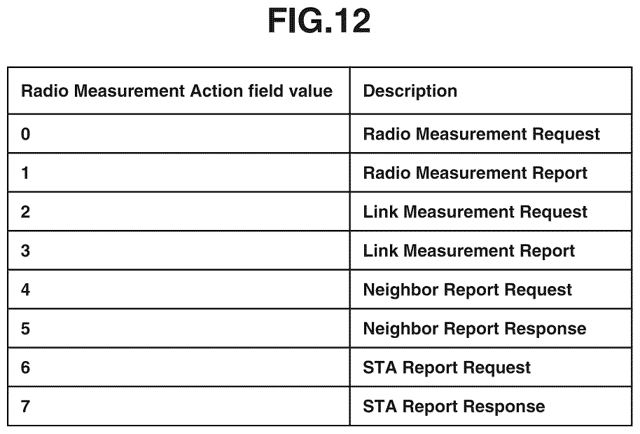

To indicate that the Radio Measurement Action frame is communicated between the AP 101 and the STA 102, 5 is stored in Category 1000. Any one of the values illustrated in FIG. 12 is stored in Radio Measurement Action. Each value indicates what type of information is requested for. In a case where information required for machine learning is requested, 6 is set to this value to indicate STA Report Request. In response to this request, 7 is set to this value to indicate STA Report Response.

Number of Repetitions 1002 indicates the number of repetitions of reporting requested for.

SSID 1003 indicates the SSID of the AP for which report is requested. This can be omitted.

STA Report Request Elements 1004 indicate the type of information to be requested to be responded by the STA 102. For example, to receive the STA positional information, information about surrounding APs that can receive a radio wave among others, and Capability information about surrounding APs, a request with the corresponding bit set to one is issued.

For STA Report Elements 1104, information corresponding to the requested information is added and transmitted. The data collection method is not limited to the collection on a request and response basis. The STA can also be configured to spontaneously transmit (submit) a status report including the data required for learning and inference, to the AP 101.

Information managed by an AP itself, such as the number of connections to the AP, is managed and recorded by the AP itself.

Referring back to descriptions of FIG. 5, when the AP 101 has collected information from the STA 102 as described above, then in step S503, the AP 101 transmits data for inference (input data required for inference) including the data measured by the AP 101 itself and the data to be managed, to the inference server 106 as metadata. In step S504, the inference server 106 returns to the AP 101 inference values of the communication throughput and communication delay when roaming to surrounding APs is performed based on input data. The AP 101 determines whether to perform the roaming based on the received inference values and the current measurement values. In a case where the roaming is required, the AP 101 also determines which AP to roam to. In step S505, in a case where the roaming is required, the AP 101 requests the STA 102 to perform the roaming processing. In response to the STA 102 receiving a roaming processing request, the STA 102 performs the roaming based on the request. At this timing, the AP 101 may transmit the information about the STA 102, keys to be used at the time of communication and authentication, and Capability information to the roaming destination AP at the same time. The roaming request may be added Transition Reason Code Attribute using MBO Attribute.

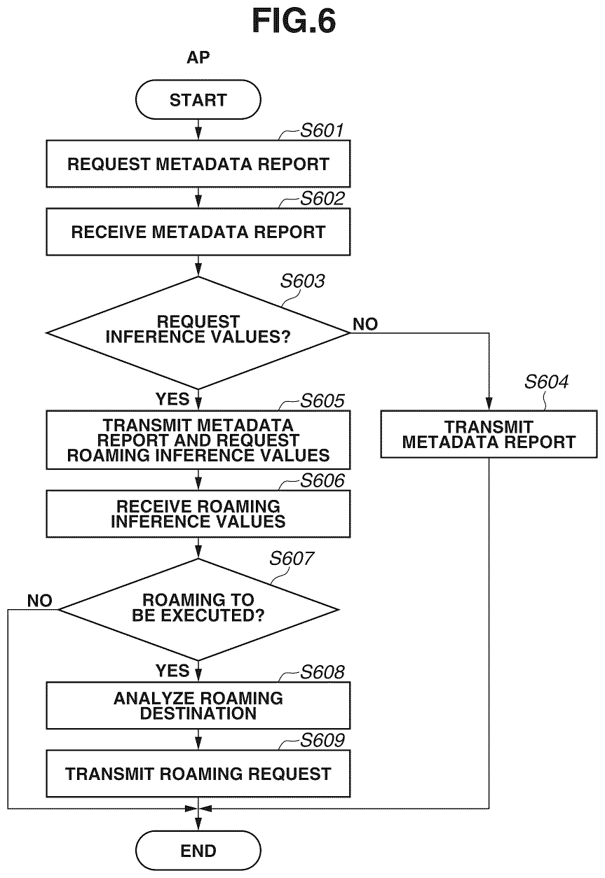

FIG. 6 is a flowchart illustrating processing performed by the AP 101 at the time of learning and inference. The AP 101 starts this processing at fixed intervals after starting the connection to an STA. In step S601, the AP 101 requests the STA data from the STA 102. This is implemented in step S501 in FIG. 5. In step S602, the AP 101 receives a response to the request. In step S603, the AP 101 determines whether to request inference values of the roaming from the inference server 106 for, based on the STA data. If the inference values are not to be requested, the AP 101 transmits the collected metadata to the data collection server 105 in step S604 and then completes the processing. The metadata that has been collected and is to be transmitted to the data collection server 105 includes at least the information indicating the effect of the past roaming collected from the STA. If the inference values are to be requested, the AP 101 transmits a metadata report to the inference server 106 in step S605. In step S606, the AP 101 receives a response of the inference values. In step S607, the AP 101 determines whether the STA 102 needs to perform the roaming based on at least the received inference values. If the roaming is required (YES in step S607), the processing proceeds to step S608. In step S608, the AP 101 analyzes the roaming destination AP and then collects information. The inference processing in step S606 and the determination processing in step S607 are collectively referred to as calculation processing. Information about whether to perform the roaming obtained as a result of the calculation processing is also referred to as a calculation result. At this timing, the AP 101 may notify roaming destination candidate APs of the information about the STA 102 and connection parameters. In step S609, the AP 101 transmits a roaming processing request to the STA 102. In a case where there is at least one STA that has been determined to perform the roaming, the AP 101 transmits a roaming processing request to the at least one STA. At this timing, the STA 102 may transmit and receive connection parameters of the connection destination candidate APs. The AP 101 may also transmit connection parameters to the connection destination candidate APs based on the result.

Even in a case where the AP 101 requests the inference value, the AP 101 may transmit metadata to the data collection server 105 after receiving the inference values. After the STA 102 successfully completes the roaming, the communication throughput and communication delay at that time may be transmitted together, to be used as output data of the learning. As for the data, the AP 101 may transmit data that has received from the roaming destination AP together with previously recorded data, or together with information that the roaming destination AP has received from the AP 101, to the data collection server Alternatively, each of the AP 101 and the roaming destination AP may transmit metadata, and the data collection server may record the AP data before the roaming and the AP data after the roaming together. If the data collection server combines the data, each of the AP 101 and the roaming destination AP may transmit a set of information about each AP, information about the STA, and roaming ID to the data collection server.

The STA that has received the roaming processing request performs the roaming based on the connection parameters. The STA also collects the above-described information before and after the roaming, and stores the information as information indicating the effect of the roaming. The connection parameters may be configured to include information required to perform Fast Initial Link Setup (FILS) defined by IEEE802.11ai. In this case, the STA performs FILS-based packet exchange with the roaming destination AP to implement high-speed connection and authentication processing.

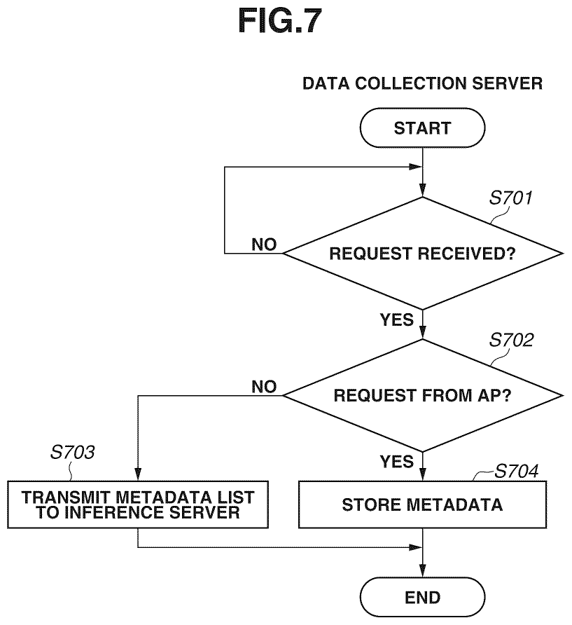

FIG. 7 is a flowchart illustrating a processing flow of the data collection server 105 at the time of training and inference. This processing is constantly performed by the data collection server 105.

In step S701, the data collection server 105 waits for a request from the AP 101 or the inference server 106. In response to receiving a request, the processing proceeds to step S702. In step S702, the data collection server 105 changes the processing according to the transmission source of the request. If the request is received from the inference server 106 (NO in step S702), the data collection server 105 determines that the request is a data list request for learning, and the processing proceeds to step S703. In step S703, the data collection server 105 transmits the recorded metadata list to the inference server. If the request is received from the AP 101 (YES in step S702), the data collection server 105 determines that the request is a metadata recording request issued to the data collection server 105, and the processing proceeds to step S705. In step S705, the data collection server 105 stores the metadata. The criterion of the determination does not necessarily need to be the transmission source address. For example, specifications of the request may be described in the request frame.

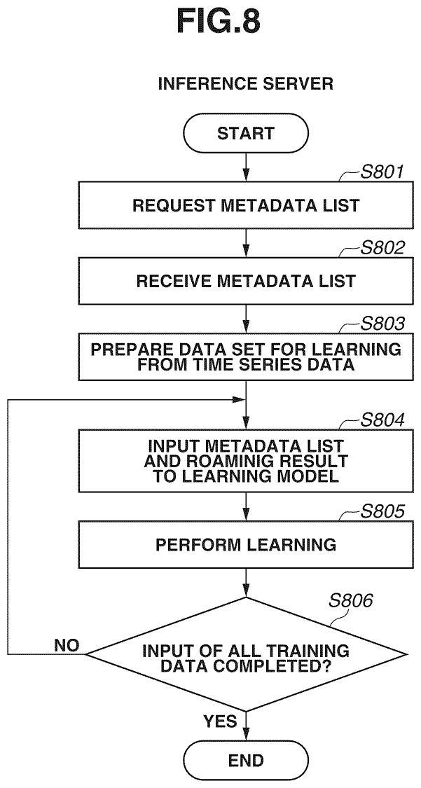

FIG. 8 is a flowchart illustrating processing of the inference server 106 at the time of learning.

The generation and updating processing for a learning model performed by the inference server is periodically performed as described above in conjunction with FIG. 5.

In step S801, the inference server 106 requests a metadata list from the data collection server 105. In step S802, the inference server 106 receives a metadata list from the data collection server 105. In step S803, based on time series data, the inference server 106 prepares a data set to be used for learning, based on the roaming result (information indicating the effect of the roaming) and the collected data at the time when the roaming is performed. In the present exemplary embodiment, uses the communication throughput after the roaming and the communication delay after the roaming are used as past result data (teacher data), but other data may be used. For example, taking the above-described configuration into account, binary data indicating successful roaming or failed roaming may be formed for use as teacher data. In this case, for example, if the communication performance after the roaming satisfies a communication index requested by an application, successful teacher data is formed. On the other hand, if the communication performance after the roaming does not satisfy the communication index requested by an application, failure teacher data is formed. In addition, the communication performance in the roaming source AP may be compared with the communication performance in the AP after the roaming. If an improvement equal or greater than a predetermined degree is achieved, successful teacher data is formed. If an improvement equal to or greater than the predetermined degree is not achieved, failure teacher data is formed. If teacher data for learning also uses an error rate and the error rate has been obtained as an inference result, the necessity of the roaming can be determined in consideration of the error rate. For example, failure teacher data is formed in a case where the inferred error rate after the roaming is excessively high. If teacher data is formed as binary data in this way, the inference server 106 generates a learning model that outputs a value indicating the possibility of the roaming being successful as an inference result.

The input data may be all data during a certain continuous period. For example, the input data may be a collection of pieces of data sampled at intervals of one minute regarding past daily data. The period of the input data is an example.

In step S804, the inference server 106 inputs a data set to be used for learning to the learning model. The data set includes the metadata list (input parameters) prepared in step S803 and the roaming result (teacher data). In step S805, the training unit 333 of the inference server 106 performs training processing on the model data based on the input parameters. For example, in a case where a learning model is to be built by using a neural network, the inference server 106 updates a coupling weighting coefficient between nodes of a convolutional neural network so that an output value of the neural network approaches a target value. The inference server 106 determines an adjustment amount for the coupling weighting coefficient by using an error function representing error information between the teacher data and an output value output by using the model data under training.

In step S806, the inference server determines whether input of the entire data set prepared in step S803 is completed. If input of the entire data set is completed (YES in step S806), the inference server completes a series of the training processing. If input of the entire data set is not completed (NO in step S806), the processing returns to step S804. In step S804, the inference server continues the training of the model data based on the data set that has not been input. The inference server repetitively performs the operations in steps S804 and S805 to gradually optimize the coupling weighting coefficient, thus building trained model data configured to output an output value having a small error from the target value.

The above-described processing enables building trained model data for roaming processing.

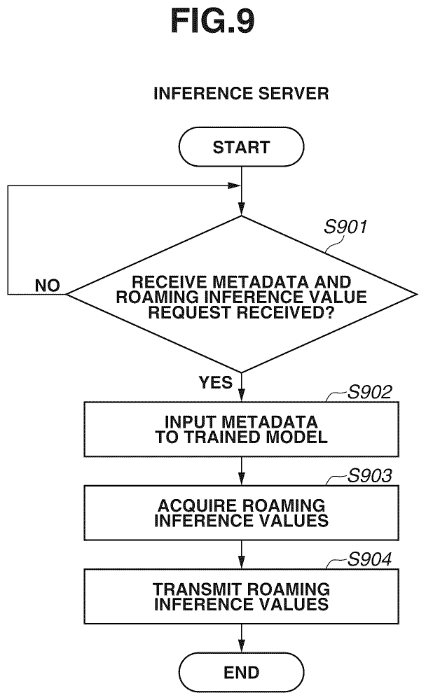

FIG. 9 is a flowchart illustrating processing performed by the inference server 106 at the time of inference. This processing is intended to be constantly executed. As described above, the inference processing may also be executed by the AP 101. In this case, each operation in FIG. 9 may be executed not by the inference server but by the AP 101. In step S901, initially, the inference server 106 receives input data from the AP101 and determines whether a roaming inference value is requested.

If the request is received (YES in step S901), the processing proceeds to step S902. In step S902, the inference server 106 inputs the input data to the trained model. At this time, if the format of the received metadata is different from the format of the input data, the inference server 106 converts the format of the input data via the training data generation unit 332.

In step S903, the inference server 106 acquires the inference values from the learning model. In step S904, the inference server 106 returns the acquired inference values to the AP 101.

After the generation of a learning model in the processing illustrated in FIG. 8, the inference server may distribute the entire learning model to all of the target APs including the AP 101. In this case, the processing in the drawing will be performed in the AP 101. At this timing, after the acquisition of roaming inference values, the AP 101 determines whether the STA 102 performs the roaming, and issues a notification to the STA 102.

The AP determines the necessity of the roaming for the connected STA by using frames conforming to the IEEE802.11 standard according to the present disclosure. If the roaming is required, the AP issues a notification to the STA.

### Modifications

Although, in the present exemplary embodiment, standard names such as IEEE802.11 HR are used as examples of successor standards of IEEE802.11be, the present exemplary embodiment is not limited thereto. Examples of standard names include High ReLiability (HRL). Examples of standard names include High Reliability Wireless (HRW). Examples of standard names include Very High Reliability (VHT). Examples of standard names include Extremely High Reliability (EHR). Examples of standard names include Ultra High Reliability (UHR). Examples of standard names include Low Latency (LL). Examples of standard names include Very Low Latency (VLL). Examples of standard names include Extremely Low Latency (ELL). Examples of standard names include Ultra Low Latency (ULL). Examples of standard names include High Reliable and Low Latency (HRLL). Examples of standard names include Ultra-Reliable and Low Latency (URLL). Examples of standard names include Ultra-Reliable and Low Latency Communications (URLLC). Examples of standard names include other names.

Part of the data set for training (combinations of an input value and teacher data) generated by the training data generation unit 332 can be utilized not only for learning but also for performance evaluation of a trained data model. The inference server 106 does not intentionally use, for learning, a part of the data set generated by the training data generation unit 322 but separately stores the data as a data set for evaluation. For the trained model data, the data set for evaluation is a combination of an unknown input value not that has not been used for learning in the past and teacher data (correct answer data).

The inference server 106 calculates an inference result by using the trained model data having been trained by the training unit 333 and the input value of the data set for evaluation. Subsequently, the inference server 106 compares the inference result with the teacher data to evaluate the performance of the trained model.

If the correct answer rate exceeds a predetermined threshold value (for example, 90%) as a result of the performance evaluation, the operation of the inference processing.

Although, according to the above-described exemplary embodiment, the inference server periodically performs the learning model generation and updating processing as described above in conjunction with FIG. 5, the present exemplary embodiment is not limited thereto. For example, the performance evaluation by using the trained model data and the data set for evaluation may be periodically performed, and the trained model updating and generation processing may be performed based on an evaluation result. For example, if the correct answer rate falls below a predetermined threshold value, the updating processing is performed. If the correct answer rate further decreases and falls below a second predetermined threshold value, the current trained model may be discarded and a new trained model may be built.

Further, in the present exemplary embodiment, a description has been provided of an example case where supervised training is used for model data generation, but this is not restrictive. For example, a learning model may be generated through a combination of the supervised learning and reinforced learning. In this case, a data set having a combination of teacher data and the surrounding status is used as data for pre-learning. In this case, the inference server 106 generates demonstration data based on the data set that combines the teacher data and the surrounding status in the surrounding environment. This demonstration data serves as a foothold in an early stage of the reinforced learning. In response to completion of prior learning of a value function and policy based on the demonstration data, the reinforced training and inference phases based on real data are proceeded. In other words, imitative learning equivalent to the supervised training is performed to generate a model for the early stage of training. In the subsequent reinforced training and inference phases, the inference server 106 determines to perform a certain action for the roaming determined based on the Markov determination process. The AP performs the roaming based on the action. The STA measures the communication status before and after the roaming, and stores the above-described information about the effect of the roaming. The inference server 106 immediately gives a return to an agent based on the effect of the roaming and updates the value function. These pieces of processing are repeated to perform additional learning. In this reinforced learning, since an action is selected based on the Markov determination process, a new action that has not been attempted for the teacher data may be selected and executed. Then, based on the actual result of this new action, the inference server 106 evaluates the action and adjusts the policy of the agent. Therefore, as the additional learning progresses, the policy of the agent is adjusted to the details to be evaluated in the real environment. Since the value function is updated over time based on the observed evaluation, not only a short-term action but also a forward action is selected. As described above, the use of the reinforced learning makes it difficult to evaluate an action causing repetitive roaming, which is called ping-pong roaming, where an AP and another AP impose the STA, and therefore such an action is hardly selected as a policy as the reinforced learning progresses. As described above, the present exemplary embodiment can be suitably modified to configure, update, and infer a model through the reinforced learning.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The processor or circuit may include a Central Processing Unit (CPU), Micro Processing Unit (MPU), Graphics Processing Unit (GPU), Application Specific Integrated Circuit (ASIC), and Field Programmable Gate Array (FPGA). The processor or circuit may also include a Digital Signal Processor (DSP), Data Flow Processor (DFP), and Neural Processing Unit (NPU).

The present invention is not limited to the above-described exemplary embodiments, and various changes and modifications are possible without departing from the spirit and scope of the present invention. Thus, the following claims are attached to disclose the scope of the present invention.

According to an aspect of the present disclosure, it becomes possible to determine the necessity of roaming suitable for communication and notify of a roaming destination.

1. A communication apparatus that operates as an access point (AP), the communication apparatus comprising:
at least one memory that stores a set of instructions; and
at least one processing circuit,
wherein the communication apparatus is caused, by the at least one processing circuit executing the instructions and/or the at least one processing circuit itself operating, to perform operations comprising:
transmitting, to a server, part or all of pieces of information with the information included in an inference request, the pieces of information including station (STA) positional information, a threshold value for a radio wave intensity in Basic Service Set (BSS) movement, the number of STAs to which the AP is connected, a radio wave intensity to be received from an STA to which the AP is connected, a radio wave status of surrounding APs indicated by the STA to which the AP is connected, information indicating a surrounding communication status indicated by the STA to which the AP is connected, a frequency band or channel supported by the STA to which the AP is connected, capability information for surrounding APs, and time-series data of any one of the pieces of information in unit time, wherein the inference request requests an inference of a quality of a communication with other communication apparatus in the case of performing a roaming processing;
acquiring a result of the inference of the quality of the communication;
determining whether to perform the roaming processing; and
notifying, in a case where it is determined to perform the roaming processing, said other communication apparatus of a performance of the roaming processing.

2. The communication apparatus according to claim 1, wherein the communication quality is inferred by the server based on a trained model data held by the server and the part or all of pieces of information included in the inference request.

3. A control method for performing control relating to roaming of communication, the method comprising:
transmitting, to a server, part or all of pieces of information with the information included in an inference request, the pieces of information including station (STA) positional information, a threshold value for a radio wave intensity in Basic Service Set (BSS) movement, the number of STAs to which an Access point (AP) is connected, a radio wave intensity to be received from an STA to which the AP is connected, a radio wave status of surrounding APs indicated by the STA to which the AP is connected, information indicating a surrounding communication status indicated by the STA to which the AP is connected, a frequency band or channel supported by the STA to which the AP is connected, capability information for surrounding APs, and time-series data of any one of the pieces of information in unit time, wherein the inference request requests an inference of a quality of a communication with other communication apparatus in the case of performing a roaming processing;
acquiring a result of the inference of the quality of the communication;
determining whether to perform the roaming processing; and
notifying, in a case where it is determined to perform the roaming processing, said other communication apparatus of a performance of the roaming processing.

4. A non-transitory computer readable storage medium storing a program for causing a computer to execute a method comprising:
transmitting, to a server, part or all of pieces of information with the information included in an inference request, the pieces of information including station (STA) positional information, a threshold value for a radio wave intensity in Basic Service Set (BSS) movement, the number of STAs to which an Access point (AP) is connected, a radio wave intensity to be received from an STA to which the AP is connected, a radio wave status of surrounding APs indicated by the STA to which the AP is connected, information indicating a surrounding communication status indicated by the STA to which the AP is connected, a frequency band or channel supported by the STA to which the AP is connected, capability information for surrounding APs, and time-series data of any one of the pieces of information in unit time, wherein the inference request requests an inference of a quality of a communication with other communication apparatus in the case of performing a roaming processing;
acquiring a result of the inference of the quality of the communication;
determining whether to perform the roaming processing; and
notifying, in a case where it is determined to perform the roaming processing, said other communication apparatus of a performance of the roaming processing.
